(19) United States
(12) Patent Application Publication
(10) Pub. No.: US 2003/0182138 A1
(43) Pub. Date: Sep. 25, 2003

(54) System and method for authorizing service requests for fleet vehicles

(76) Inventors: Katja Jeanneret, Chanhassen, MN (US); Dale Nicholson, Shakopee, MN (US); Steve Eggert, Chaska, MN (US); Woody Taylor, Minneapolis, MN (US); Gregg Kizewski, Dallas, WI (US); Denes Mathe, St. Paul, MN (US)

Correspondence Address: DORSEY & WHITNEY LLP, INTELLECTUAL PROPERTY DEPARTMENT, 50 SOUTH SIXTH STREET, MINNEAPOLIS, MN, 55402-1498, US

(21) Appl. No.: 10/105,887

(22) Filed: Mar. 25, 2002

(51) Int. Cl. G06F 17/60

(52) U.S. Cl. 705/1

(57) ABSTRACT

Fleet vehicles are brought into a service provider to have various services performed. The service provider accesses an automated work authorization system and provides an identification of the service provider, the vehicle, the service to be performed and their associated costs. The system processes the request to determine if the requested service is necessary or appropriate for this specific vehicle based on the current status of the vehicle as well as that vehicle's service history. In addition, the cost of the service is analyzed to determine if it is appropriate. The system can then automatically generate a work authorization and communicate the work authorization to the service provider. If the system is unable to fully process the request, the call can be transferred to a human technical assistant for further processing. All of the information gathered by the system is passed to the technical assistant and automatically populates an interface used by the technical assistant.

### FIELD OF THE INVENTION

The present invention relates to vehicle fleet management. More specifically, the present invention relates to providing service authorizations for fleet vehicles.

### BACKGROUND OF THE INVENTION

Many companies maintain a fleet of vehicles for a variety of uses. For example, a company may provide a vehicle for each member of its sales force, for each member of a marketing staff that travels often, or simply for all of its employees to facilitate travel. Such companies may have only a few vehicles or may have thousands. As may be appreciated, providing and maintaining a fleet of vehicles can be very expensive. As such, these companies seek to provide efficient ways of providing, tracking and managing these vehicles.

To that end, a company may create its own fleet management structure or may employ the services of a fleet management company. A fleet management company provides products and/or services to companies that wish to have a fleet of vehicles. As such, a given fleet management company may oversee the fleets of many different companies. For example, a fleet management company may facilitate the acquisition of the vehicles. In addition, the fleet management company may monitor and oversee various activities, such as the maintenance of those vehicles. Thus, whether provided by a separate company or handled internally, a fleet management service is often used to oversee the requirements of the vehicle fleet.

One common fleet management issue is processing and providing for the maintenance requirements of the vehicles. Routine services, major and minor repairs and emergency services may be performed on a given vehicle by any number of service providers. For example, an operator of a fleet vehicle may routinely bring that vehicle to a service provider to have the oil changed. Fleet management will have established a schedule for such services, for example once every 3000 miles. Assuming the provided service is performed within the scheduled parameters, fleet management will authorize payment for that service.

One way of dealing with the issue would be to make the vehicle operator pay for the desired service and submit a request for reimbursement. Such a method is undesirable in that it does not prescreen and preauthorize the service request. Thus, the vehicle operator could pay for non-authorized service and thus, not be reimbursed. As such, vehicle operators may be hesitant to engage in those services that should be performed.

Alternatively, fleet management can be consulted prior to performing the service to receive pre-approval. Generally, this request is made by the service provider to the fleet management service. If approval is granted, the work is authorized and the service provider performs the service. A bill is then generated and sent to the fleet management service, with an indication of the pre-approved status, i.e., an appropriate work authorization.

To facilitate such requests, the fleet management service maintains a database of the vehicles in their fleet along with their service histories and associated service parameters. To gain pre-approval, a service provider telephones a technical assistant who is a person working for the fleet management service and the service provider requests authorization for a given service. The technical assistant initially must identify the service provider and the vehicle then access the service history and the specific parameters for the vehicle in question and determine if the requested service and the quoted price are appropriate. The technical assistant then either approves or rejects the request.

In this manner, service is pre-approved and the vehicle operator may be more inclined to follow service parameters and the fleet management service can effectively control the servicing of the fleet vehicles.

Once such a system is established, routine or lower cost maintenance (e.g., preventative maintenance items such as oil changes, as well as brake repair, wear items, etc.) requests tend to represent a high volume of the requests made to technical assistants. That is, since all service is pre-approved and these types of service are the most common, it logically follows that these routine service requests are most often received. This may require additional technical assistants and/or may burden their time, causing delays in reaching technical assistants and in receiving approval for relatively low cost or straightforward maintenance or repair items. For example, it may not be beneficial to a service provider to have to wait on hold for twenty minutes to receive approval for a ten minute oil change.

Larger fleet management services currently process over one million work authorization requests per year. Simply identifying the service provider and fleet/vehicle information takes a technical assistant about one minute, with the remainder of the call length depending on the services requested. Thus, technical assistants spend a great deal of time reviewing and deciding whether to approve straightforward requests increasing the overall queuing time of the process and reducing customer satisfaction among service providers interacting with the fleet management service.

### BRIEF SUMMARY OF THE INVENTION

The present invention is a system and method for automatically processing requests for work authorizations related to servicing a fleet vehicle. The system includes a communication module that receives requests for pre-approval via voice, numeric input or other communication platforms from service providers. The service providers identify themselves, the vehicle that will be serviced, a proposed cost for the service, and an itemized list of the services to be performed. The system processes the information to determine if the requested service is appropriate for the vehicle and if the cost is appropriate for the specific service. Assuming both conditions are met, the system automatically generates a work authorization and communicates the work authorization to the service provider. If the work authorization cannot be authorized in full or in part, the call is transferred to a human technical assistant for further processing. The information gathered by the system is likewise transferred, automatically populating an interface used by the technical assistant.

The present invention, in one embodiment, is a method for automatically processing requests for work authorizations. The method includes receiving a request for the work authorization for a service through a communication module and receiving an identification of a vehicle for which the service is requested. The identification is received through the communication module. The method includes processing the request for the work authorization and generating a decision on the request for the work authorization based on the requested work authorization and a status of the vehicle.

In another embodiment, the present invention is a method of automatically processing requests from a service provider for a work authorization for a service to be performed on a fleet vehicle. The method includes establishing a connection between the service provider and a communication module. Input from the service provider is received and processed by the communication module. The method includes receiving an identification of the vehicle wherein the identification of the vehicle is provided to a vehicle history evaluation module that identifies a service history of the vehicle and receiving a request to provide the work authorization for the service. In addition, the method includes, receiving an indication of the cost of the service and processing the request based on the service history of the vehicle as well as the indicated cost of the service. The method also includes generating a decision regarding the request and communicating the decision to the service provider.

In another embodiment, the above method further includes requesting and receiving an invoice reference and then generating a work authorization reference. The method further includes communicating the work authorization reference to the service provider and storing the invoice reference and the work authorization reference along with an approved cost in memory.

In another embodiment, the present invention is a system for the automated processing of work authorization requests by a fleet management service from a service provider. The system includes a database for storing information relating to a service history of a vehicle and service codes for denoting vehicle services and acceptable costs for the services. The system also includes a communication module configured to receive information from the service provider and vehicle history evaluation module configured to obtain and process information relating the status of a vehicle for which the work authorization is requested. The system includes a cost evaluation module configured to determine if a proposed cost received from the communication module for a service for which the work authorization is being requested is below a predetermined value established for the performance of the service. The system includes a logic module configured to generate a work authorization when the vehicle history evaluation module and cost evaluation module provide an indication that the requested service and cost are appropriate.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram illustrating the interaction between a service provider, a technical assistant and a management system consistent with the principles of the present invention.

FIG. 2 is a block diagram illustrating the various modules forming the management system.

FIGS. 3A-3C illustrate a flowchart detailing the handling of service requests by the management system.

FIG. 4 is a flowchart illustrating the process for handling an invoice.

FIG. 5 is a flowchart illustrating the process of evaluating specific line items.

FIG. 6 is a flowchart illustrating the process of evaluating the pricing of service requests.

FIG. 7 is a sample screen shot illustrating a vehicle service history maintained by a fleet management service as presented in a populated technical assistant's screen.

FIG. 8 is a sample screen shot illustrating a populated technical assistant's screen.

### DETAILED DESCRIPTION

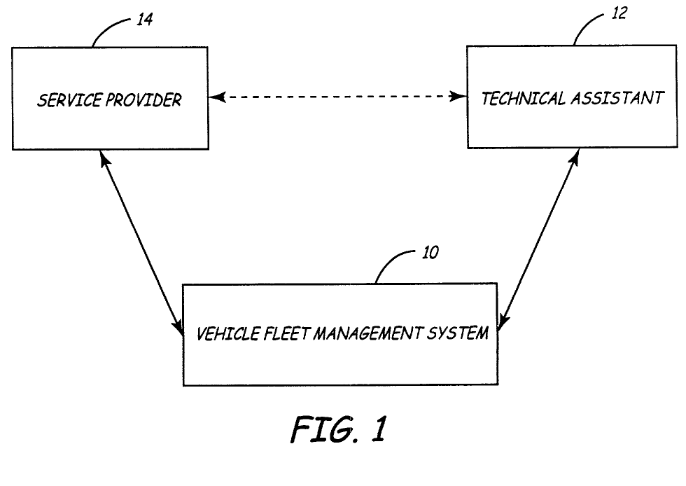

FIG. 1 is a block diagram illustrating the interaction between a management system 10, a technical assistant 12, and a service provider 14. In general, service provider 14 is representative of an entity seeking approval to perform service including maintenance, repairs, or other types of work on a vehicle that is part of a fleet of vehicles. A fleet management service, either as an independent entity that manages fleets for any number of other companies or as a part of a company managing its own fleet of vehicles, is responsible for the vehicles in that fleet.

One of those responsibilities is to facilitate the repair and maintenance of the fleet vehicles. To that end, service provider 14 works with the fleet management service to maintain the vehicle. More specifically, service provider 14 acts to perform the service on the vehicle under any guidelines established by the fleet management service and is reimbursed for that service by the fleet management service. Service provider 14 may, in some cases, have been previously affiliated with the fleet management service (e.g., a preferred provider) or may have no previous relationship with the fleet management service. In the former case, service provider 14 may be familiar with the requirements of the fleet management service, while in the later the would likely not be familiar with those requirements.

In any event, service provider 14 is either required to or chooses to seek pre-approval from the fleet management service before servicing the vehicle. Traditionally, such pre-approval is obtained by contacting technical assistant 12, who is an agent of the fleet management service. Service provider 14 identifies the vehicle and the requested service to the technical assistant 12 who reviews the service history of the vehicle in light of any guidelines established by the fleet management service and either approves, negotiates or denies the request for work authorization.

In the present invention, vehicle fleet management system 10 is provided and interfaces with service provider 14. Vehicle fleet management system 10 is an automated system that serves several functions. That is, vehicle fleet management system 10 interacts with service provider 14 to receive certain information including an identification of service provider 14, an identification of the vehicle to be serviced, an identification of the services to be performed, an identification of the proposed costs, and an identification of the status of the vehicle (e.g., current mileage, condition, etc.). Vehicle fleet management system 10 can then process that information to independently and automatically approve or deny certain work authorization requests. Thus, the fleet management service becomes more efficient by reducing the required interactions with technical assistants 12.

In addition, in cases where vehicle fleet management system 10 cannot act to resolve the request, the request is transferred to technical assistant 12. As the request is transferred, all of the relevant information already gathered is also provided to the technical assistant automatically. That is, technical assistant 12 will not need to take time to identify service provider 14, identify the relevant fleet and specific vehicle, identify the service requested, or look up the vehicle's history. All of that information will automatically and efficiently populate the technical assistant's interface, thereby streamlining the process and making it that much more efficient by reducing the time required of technical assistant 12.

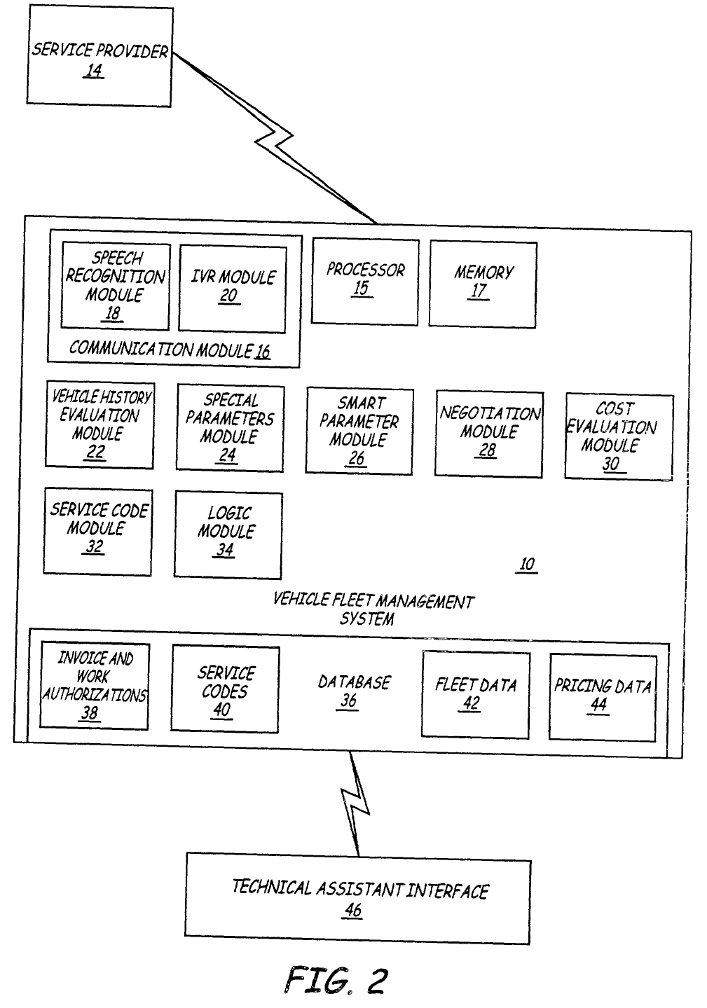

FIG. 2 is a block diagram illustrating the various modules forming vehicle fleet management system 10. As an automated system, vehicle fleet management system 10 will generally include a processor 15 and a memory 17. A communication module 16 is provided to interact with service provider 14. Communication module 16 may include a speech recognition module 18 and/or an interactive voice response (IVR) module 20 to facilitate the acquisition of data from voice or keypad entries. Communication module 16 could also include various other telephonic or electronic communication platforms. For example, electronic and/or voice data could be processed from an Internet connection. Since service providers 14 could be located anywhere, speech recognition module 18 can be customized to recognize different regional dialects and speech patterns. By using both voice recognition and IVR, information received by voice can be verified to assure its accuracy. Of course, other types of communication interfaces could by utilized such as facsimile transmissions or electronic transmissions from a computer or other electronic system utilized by service provider 14. A voice system will generally find universal acceptability while other communication interfaces may require service provider 14 to have certain specific equipment beyond a telephone.

Vehicle fleet management system 10 also includes a vehicle history evaluation module 22 programmed to evaluate criteria relating to a given vehicle's service history. Special parameters module 24 is programmed with fleet specific criteria. For example, the fleet management service may manage a large number of fleets for different companies. One company may require that their vehicles only be serviced by certain service providers or that only certain types of replacement parts are utilized. Special parameters module 24 acts to assure that these criteria are filled. Smart parameters modules 26 is programmed to review the service history of the vehicle and the information received from the service provider in order to suggest any additional service(s) that might be required or beneficial. For example, if service provider 14 is requesting authorization to repair the brakes of a vehicle, smart parameters module 26 may note that it has been well over 3000 miles since the last oil change and suggest and/or authorize that an oil change be performed as well. All of this can be based upon parameters stored within database 36. The information specific to particular fleets is maintained in fleet database 42.

Assuming vehicle fleet management system 10 will approve the performance of a given work authorization request, the next issue will be the cost of the requested service. Cost evaluation module 30 is programmed to compare the requested pricing with guidelines in pricing database 44. If acceptable, the request can be approved. However, if the requested authorization is too high, negotiation module 28 is programmed to interact with service provider 14 to negotiate a different price. This can simply be validating a maximum price that can either be rejected or accepted by service provider 14 or a more complex negotiation can be facilitated.

Service code module 32 is provided to itemize or standardize the various service options that might be requested. In one embodiment, codes based on the American Trucking Association (ATA codes) are utilized. This simply provides a standard protocol for the system 10 to function under. For example, an oil change has a code of 040-001, wherein the major code “040” is representative of the category “preventative maintenance” and the minor code “001” specifies the specific service. There are major codes to cover each portion of a vehicle (e.g., ignition system, frame, suspension, etc,) and various service or maintenance categories (e.g., preventative maintenance, accident repair, etc.). While ATA codes represent one standardized system that can be utilized, various other systems could be utilized as well. The service code data is stored in service code database 40. Service code module 32 is also configured to translate information received from communication module 16 into the appropriate service code. That is, variations in terminology need to be correlated to a standard. For example, service provider 14 may request authorization for a “lube, oil and filter” and service code module 32 can recognize this as an “oil change.”

Logic module 34 is programmed to coordinate all of the functions and modules described herein. Specifically, logic module 34 evaluates the work authorization request and based on the stored parameters, utilizes the other modules as necessary to process the request. As may be appreciated, system 10 can be provided in a specific hardware configuration, software configuration or combination of the two. The software information can be stored on a storage medium, such as a computer disk, hard drive, or memory device, or propagated as signals through an electronic medium. System 10 can be practiced with one or more computers or various electronic devices, alone or coupled together.

If a work authorization request is approved, that approval information is stored within invoice and work authorizations database 38. In addition to the work authorization, an invoice number or other reference is provided by service provider 14 and stored. Subsequently, when an invoice is received by the fleet management service from service provider 14, that invoice is compared with the data in invoice and work authorizations database 38. If the invoice matches the stored data, the invoice is processed. If the two do not match, additional inquires can be performed.

As previously explained, service provider 14 interfaces with vehicle fleet management system 10 through communication module 16. Should vehicle fleet management system 10 be unable to fully address all requests made by service provider 14, service provider 14 will be transferred to a technical assistant 12. In addition, all of the information gathered from service provider 14, including information relating to the vehicle, the work authorization requests made (if any), and any conclusions and analysis made by vehicle fleet management system 10 automatically populate technical assistant interface 46, thus saving a tremendous amount of time.

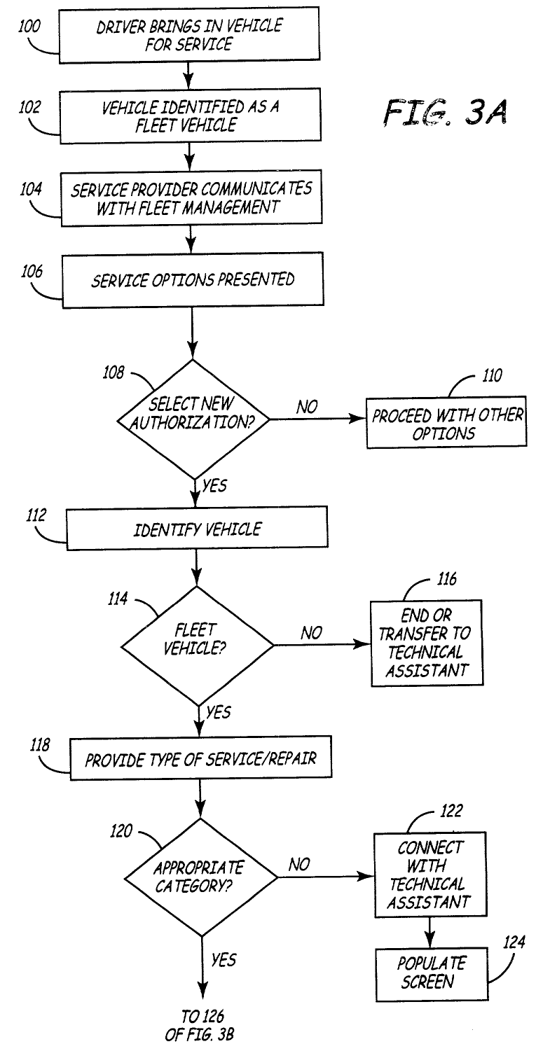

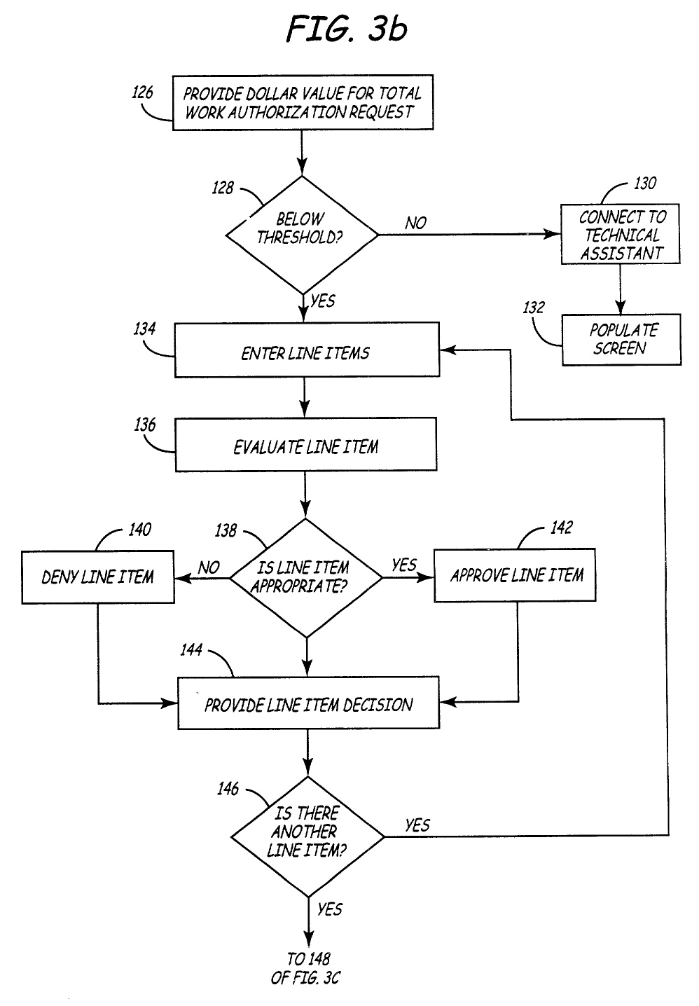

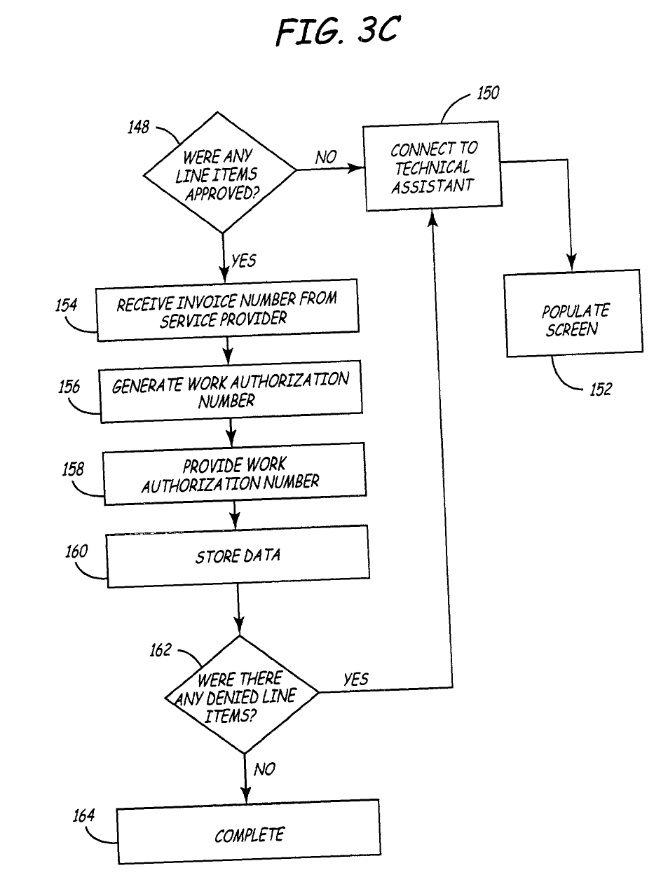

FIGS. 3A-3C are flowcharts illustrating the processes performed when service provider 14 requests a work authorization from a fleet management service using vehicle fleet management system 10. Initially, the driver of the vehicle will bring (100) the vehicle to service provider 14 for some type of service. Of course, the driver will communicate the particular concern to service provider 14. Service provider 14 will also recognize the vehicle as being a fleet vehicle (102). That is, the driver will communicate this information, service provider 14 may already have this vehicle in their system from previous service visits, or some fleet identification may be provided on the vehicle itself

Once identified as a fleet vehicle, service provider 14 decides, or is required to seek pre-approval for the work to be performed. As such, service provider 14 contacts (104) vehicle fleet management system 10 by telephone or any other suitable means. In this embodiment, communication is conducted via telephone and voice recognition along with IVR are utilized. System 10 may provide (106) a number of options to service provider 14 such as a new authorization request, payment inquiry, or various follow up options. If service provider does not select a new authorization (108) the system will proceed with whatever option (110) is chosen in an appropriate manner. Service provider 14 identifies themselves to system 10. This can be done by a phone number or by any other unique identifier assigned to or utilized by service provider 14. If service provider 14 has previously been associated with the fleet management service, service provider's 14 contact information can be obtained from database 36. If this is the first time service provider 14 has requested an authorization, they may be prompted to provide any required identifying information.

Assuming a new authorization is requested (108), service provider 14 is prompted to identify the vehicle (112). This can be done by speaking or keying a fleet identification number, a VIN (vehicle identification number), a license plate number, or any other unique identifier. The identification can be confirmed and service provider 14 can be given an opportunity to correct any errors. For example, after speaking an identification number, communication module 16 can repeat the identification number as received and ask for confirmation. System 10 then determines or confirms whether or not this particular vehicle is a fleet vehicle (114) managed by the fleet management service. If it is not (116), the call can be terminated or transferred to a technical assistant 12 for further assistance.

Once identified as a fleet vehicle, system 10 then prompts service provider 14 to select a service category 118 for the work authorization being requested. System 10 evaluates the service category (120) to determine if it is appropriate for automated handling. However, some fleet management services may define specific categories of service that should always be handled by a technical assistant (e.g., tire replacement, diagnostics, etc.). Which, if any, such service categories exist will depend upon the specifics of the fleet management service. If the service category provided by service provider 14 is not handled by system 10, then service provider 14 is transferred (122) to technical assistant 12 and the technical assistant's interface 46 is populated with the data gathered so far. This data would include a complete identification of the service provider, the vehicle in question, and an indication of the type of work for which pre-approval is being requested.

Assuming the service category is appropriate for system 10, service provider 14 is prompted to enter a total dollar value for the work authorization request. This would be a total for all of the services being requested, if multiple services are to be performed. System 10 then determines whether the total provided is below a predetermined threshold (128). As will be explained in greater detail, different threshold levels may be employed for different reasons. In general, the fleet management service may prefer that work exceeding a certain value be pre-approved by technical assistant 12 to minimize risk. Thus, if the value entered exceeds the threshold value, service provider 14 is connected (130) with a technical assistant 12 and interface 46 is populated (132) with the gathered information. If the entered value is below the threshold, system 10 prompts service provider 14 to enter the individual line items (134). A line item could be an oil change, brake pad replacement, or any individual service item. For example, as explained above a major and a minor ATA code together define a line item. A cost for each line is also requested and received.

System 10 evaluates (138) each line item based on various factors. For example, cost will almost always be a factor. That is, even if a total work authorization falls below a threshold value, the cost for a given line item may exceed specific parameters. Vehicle history evaluation module 22 also reviews the service history of the vehicle to determine if the service is appropriate. For example, if brake pads were replaced only 1000 miles ago, a request to replace them again would not likely be justified. Of course, the specific parameters reviewed will depend on the line item requested. Oil changes and the like may simply be mileage dependant. More significant repairs may be reviewed in light of driver complaints, previous servicing, manufacturer guidelines or any number of other established parameters.

In any event, system 10 evaluates each line item (138) and either denies (140) or approves (142) that line item and communicates (144) the decision to service provider 14. System 10 then asks service provider 14 whether there is another line item (146). If yes, system 10 returns (134) and allows service provider 14 to enter each line item and then proceeds to evaluate that line item. When no further line items are to be entered, system 10 reviews the process and determines if any line items were approved (148). If not, there is no more that system 10 can do for service provider 14 and the call is transferred to technical assistant 12 and interface 46 is populated.

Assuming at least one line item was approved (148), system 10 prompts service provider 14 to enter (154) an invoice number and stores this number in database 36. System 10 then generates (156) a work authorization number (158) and stores (160) this number with the invoice number. The work authorization number is communicated to service provider 14.

If there were no denied line items (162), the call is completed (164) and service provider 14 is authorized to perform the work. If there were some denied line items, service provider 14 can either dismiss them or connect with technical assistant 12 to discuss the denied line items. There may be any number of reasons why a denied line item may be approved by technical assistant 12. For example, if brake pads were just recently replaced system 10 may deny an automated request to replace them. However, service provider 14 may explain a unique circumstance (an accident, for example) that justifies why such service is actually warranted. Some of these unique circumstances may be entered into system 10, altering the approval parameters. The level of complexity of system 10 can vary as desired. Thus, system 10 is not meant to replace all interaction with technical assistant 12, but rather to limit that interaction to only those situations that require it.

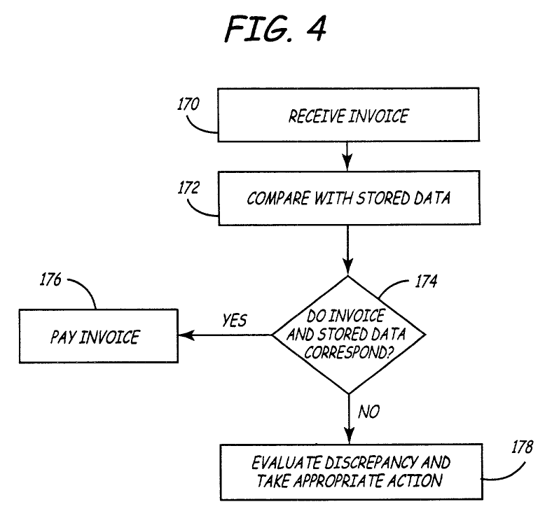

Referring to FIG. 4, after providing the service, service provider 14 will generate an invoice and denote the work authorization number that was received. That invoice is then sent to the fleet management service (170) where it is compared (172) to the information previously stored in database 36. If the received invoice and stored data correspond (174) the invoice is processed and paid (176). If there is some discrepancy, that discrepancy is evaluated (178) and the appropriate action is taken. For example, the invoice may be for a higher amount than authorized. The fleet management service may simply pay the agreed upon price or may contact service provider 14 to inquire about the difference.

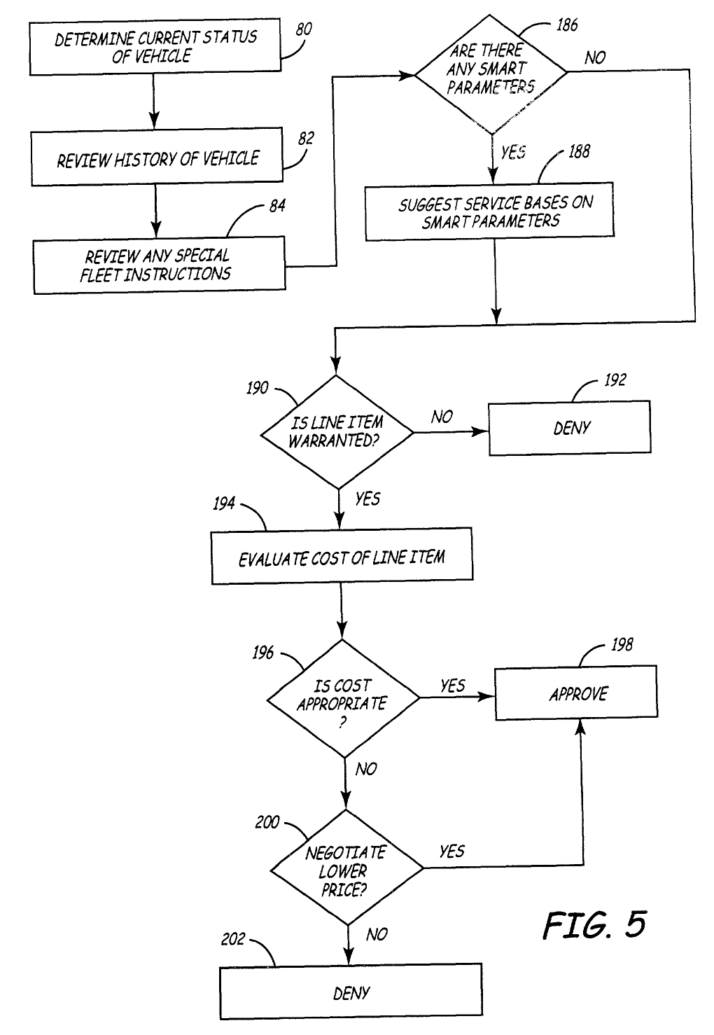

FIG. 5 is a flowchart illustrating the evaluative process performed by system 10 in greater detail. Initially, system 10 will process information provided by service provider 14 (e.g., mileage, thickness of brake pads, etc.) to determine the current status (180) of the vehicle. Vehicle history evaluation module 22 will then obtain and evaluate (182) the vehicle's service history stored in database 36. With the particular vehicle identified, special parameters module 24 will obtain any instructions (184) relevant to the vehicle. For example, there may be instructions to utilize only certain types of replacement parts, or only certain service providers for particular repairs. These instructions are reviewed and if required, communicated to service provider 14. These instructions may also play a part in the review of specific line items, as discussed below.

Smart parameters module 26 evaluates the vehicle's service history to determine if there are any specific services that should be performed (186) in addition to those requested by service provider 14. For example, service provider 14 may be requesting authorization to perform brake repair and smart parameter module 26 may determine that the vehicle also needs to have an oil change. In addition, requested line items (e.g., specific ATA codes) can trigger various smart parameters. For example, a parameter could be established that would suggest the brake fluid should be replaced any time the brake pads are replaced. That is, smart parameter module 26 will determine additional service options based on the vehicle's history and various other factors and suggest (188) those options to service provider 14. These smart parameters can be fleet specific, vehicle specific or specific to the fleet management service. Service provider 14 can agree to perform the additional services and the work can be authorized, assuming pricing is appropriate.

System 10 then begins to evaluate each of the requested line items (190). If the line item is unwarranted, it is denied (192). A line item may be unwarranted, for example, if the same or similar service was performed too recently. In the case of wear items, their replacement (or repair) can usually be objectively determined either from the service history and current status of the vehicle or from information provided by service provider 14. For example, rotor replacement will be authorized if scoring extends to a predetermined depth. If the line item is warranted based on the evaluation of the service history, provided information, and any special instructions present, cost evaluation module 30 then evaluates the cost of the line item (194). If the cost is appropriate, the line item is approved (198). The cost will be appropriate if it falls within predetermined pricing parameters for a given service and more specifically for a given line item. If the price is not appropriate, negotiation module 28 can attempt to negotiate an appropriate price (200). This can occur by simply stating that the line item exceeds corresponding price guideline and asking for a lower price or a more complex automated negotiation can be performed. If an acceptable price is negotiated, the line item is approved (198), if not the line item is denied (202). Any remaining line items are similarly evaluated.

An additional consideration in the cost evaluation is the warranty on the vehicle. That is, a requested service may be covered under an existing warranty. As such, service may be authorized (an ultimately paid for) under warranty, if applicable. However, a service request may in fact be denied if such warranty service needs to be performed by a different service provider under the terms and conditions of the warranty. System 10 evaluate the parameters of the warranty and prompts the appropriate action. Reasons for denial, such as warranty specific requirements, can be communicated to service provider 14 so that service provider 14 will understand the conclusion and not be compelled to pursue the issue with technical assistant 12.

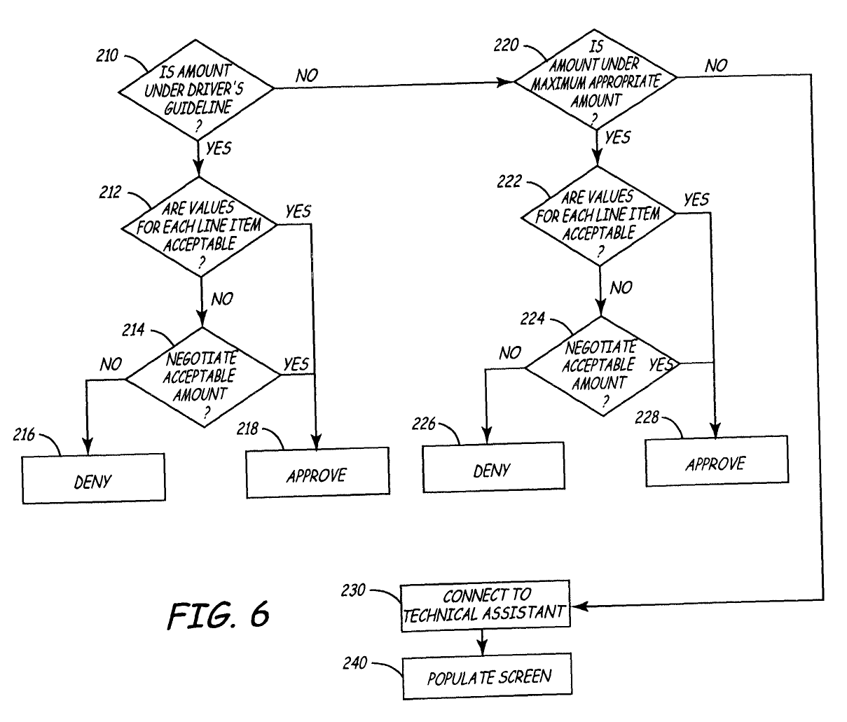

FIG. 6 is a flow chart illustrating the threshold determination process in greater detail. As explained above, service provider 14 will be requested to provide a total amount expected for the work authorization (126 of FIG. 3B). In one embodiment, system 10 initially determines if the amount input is below a given guideline (210). This guideline may be a service amount that the driver of a vehicle can actually authorize on his own, without requiring pre-approval from the fleet management service. That is, the fleet management service may decide that it is simply easier to allow smaller charges without taking the time to evaluate and pre-approve the charge. Thus, a driver with such a guideline could bring the vehicle in for an oil change and authorize the service without obtaining pre-approval for the service so long as the amount is below the driver's guideline amount. A generated invoice for such service will be processed and paid by the fleet management service.

Despite this, many service providers 14 still seek to obtain a work authorization even though the total cost of service will be below this guideline and such pre-approval is unnecessary. Service provider 14 (or the driver) may simply be unaware of the driver's allowance, may simply overlook the issue, may be more comfortable in receiving a work authorization for all work provided, or may request the work authorization for any number of other reasons. In actuality, requests for pre-approval for service items below the this guideline represent a large percentage of the call volume handled by a fleet management service, leading to increased costs and delay time.

Thus, system 10 is ideally suited for handling service requests for amounts under the this guideline. Utilizing system 10 subjects these requests to a level of scrutiny they would otherwise not receive if pre-approval were not sought. That is, system 10 evaluates the cost of each line item (212) even though that cost is below the guideline. For example, assume the guideline is $75.00. That is, the driver can authorize any minor service costing less than $75.00 without having to seek pre-approval. Thus, an oil change costing $50.00 could be obtained by the driver and service provider 14 would be reimbursed. However, if service provider 14 seeks pre-approval anyway, the cost for the line item, in this case the oil change, is evaluated. Assuming the maximum allowable amount for an oil change is $35.00, this line item will be negotiated to a lower amount (214) or denied (216). Thus, in this embodiment the line item needs to be below the guideline and within the appropriate parameters for the specified service, in order to be approved (218). Thus, the fleet management service benefits by not requiring a technical assistant's time in evaluating charge below the driver's guideline, but also benefits from only approving charges within predefined parameters. The fleet management service saves money by not paying for service requests that would otherwise have been paid for as a matter of convenience. Thus, fleet management services utilizing system 10 can continue to utilize the guideline amounts as a matter of convenience or may choose to eliminate that option and require pre-approval for all charges, relying on the efficiency of system 10.

If the total amount requested for work authorization exceeds the guideline, system 10 can be configured to require approval from a technical assistant. Alternatively, a higher maximum approval amount can be established for system 10. That is, system 10 can effectively handle work authorization requests for amounts in excess of these guidelines. The fleet management service will likely impose some maximum that can automatically be approved in order to assure that higher priced service are reviewed by a technical assistant 12 prior to approval. The actual maximum amount can vary depending upon the specific parameters established by the fleet management service.

So long as the requested work authorization amount is below the maximum approvable amount (22), system 10 can process the request. System 10 determines if the cost of each line item is appropriate (222). If it is, the line item is approved (228). If it is not, system 10 can attempt to negotiate a lower price (224). If an acceptable price is negotiated, the line item is approved (228), if not the line item is denied (226).

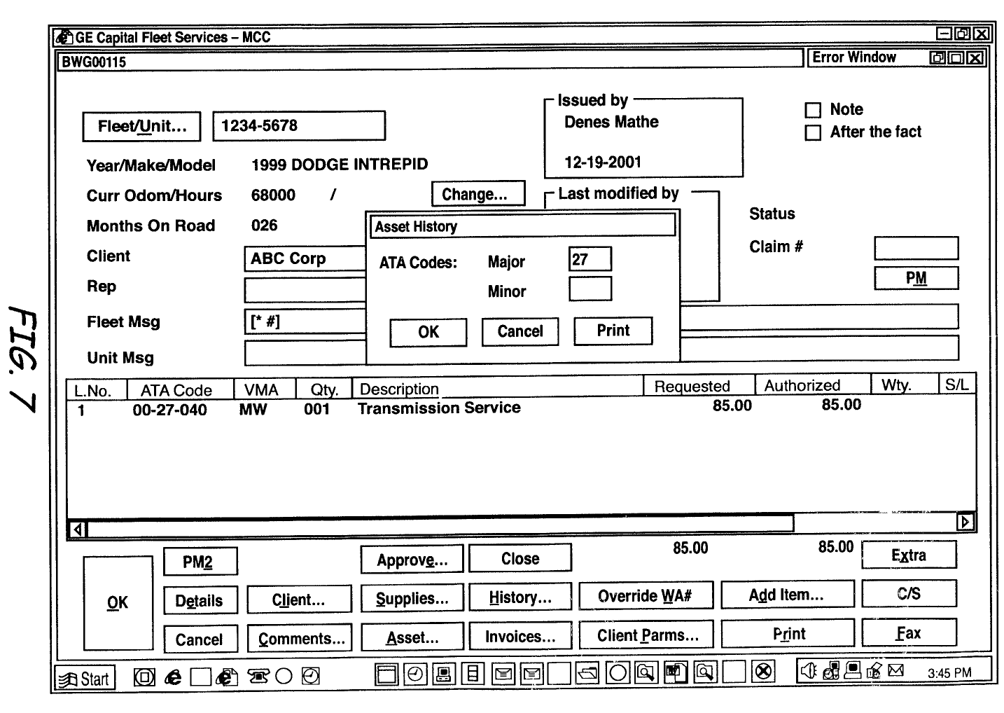

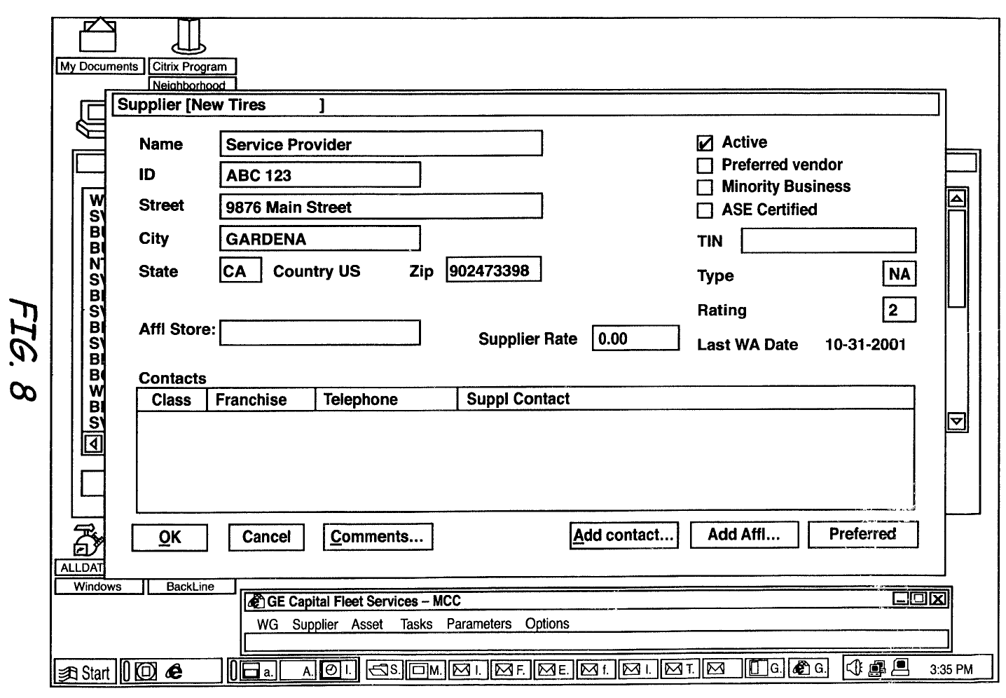

If there are denied line items or if the initial amount requested for approval exceeds the given guideline and the maximum approvable amount, service provider 14 is connected to a technical assistant (230) and their interface 46 is populated (240) with the relevant information. FIGS. 7 and 8 illustrate sample screen shots showing how information gathered by system 10 can populate technical assistant interface 46. Such information can include, but is certainly not limited to: a fleet and vehicle identification, specific vehicle parameters (make, model, mileage), time in service, a client identifier (i.e., whose fleet is it), codes for the line items in question, approval status, service provider identification, and type of service provider

Although the present invention has been described with reference to preferred embodiments, persons skilled in the art will recognize that changes may be made in form and detail without departing from the spirit and scope of the invention.

We claim:

1. A method of automatically processing of requests for a work authorization comprising:
receiving a request for the work authorization for a service through a communication module;
receiving an identification of a vehicle for which the service is requested, the identification being received through the communication module;
processing the request for the work authorization; and
generating a decision on the request for the work authorization based on the requested work authorization and a status of the vehicle.

2. The method of claim 1, wherein the communication module includes a speech recognition module.

3. The method of claim 1, wherein the communication module includes an interactive voice response module and a speech recognition module.

4. The method of claim 1, wherein the communication module includes an electronic communication module.

5. The method of claim 1 and further comprising receiving an identification of a service provider requesting the work authorization.

6. The method of claim 1, further comprising:
receiving an indication of a cost for the service;
determining if the cost exceeds a predetermined threshold for the service; and
denying the request for service if the cost exceeds the predetermined threshold.

7. The method of claim 1, further comprising transferring a service provider requesting the work authorization from the communication module to a technical assistant if the cost is determined to exceed the predetermined threshold.

8. The method of claim 1 wherein the identification of the vehicle also includes an identification of a vehicle fleet.

9. The method of claim 1, wherein the service is correlated to a unique identifier.

10. The method of claim 9, wherein the unique identifier is chosen from ATA codes.

11. A method of automatically processing requests from a service provider for a work authorization for a service to be performed on a fleet vehicle, the method comprising:
establishing a connection between the service provider and a communication module, wherein input from the service provider is received and processed by the communication module;
receiving an identification of the vehicle wherein the identification of the vehicle is provided to a vehicle history evaluation module that identifies a service history of the vehicle;
receiving a request to provide the work authorization for the service;
receiving an indication of the cost of the service;
processing the request based on the service history of the vehicle, and the indicated cost of the service;
generating a decision regarding the request; and
communicating the decision to the service provider.

12. The method of claim 11, further comprising:
receiving an indication of a current status of the vehicle, wherein processing the request is further based on the current status of the vehicle.

13. The method of claim 12 wherein the indication of the current status includes a current mileage of the vehicle.

14. The method of claim 11, wherein the indicated cost of the service is a total for all services for which work authorization will be requested.

15. The method of claim 14, wherein if the cost of the service exceeds a predetermined threshold the service provider is transferred to a technical assistant.

16. The method of claim 15, wherein if the service provider is transferred to the technical assistant information indicative of the vehicle, the vehicle's service history and the request for work authorization populates a technical assistant's interface.

17. The method of claim 16, wherein information identifying the service provider is also received and transferred to the technical assistant's database.

18. The method of claim 15 wherein the predetermined threshold is a guideline amount established for the fleet.

19. The method of claim 11, further comprising:
identifying any additional parameters associated with the vehicle; and
communicating the additional parameters to the service provider.

20. The method of claim 19 wherein the additional parameters include specific requirements.

21. The method of claim 19, wherein the additional parameters include additional service items that should be performed on the vehicle.

22. The method of claim 11, further comprising:
receiving an invoice reference;
generating a work authorization reference;
communicating the work authorization reference to the service provider; and
storing the invoice reference and the work authorization reference along with an approved cost in memory.

23. The method of claim 11 wherein processing the request includes evaluating a current status of the vehicle, a previous time the service may have been performed, and a predetermined interval for performing the service.

24. The method of claim 23 wherein processing the request further includes evaluating current physical parameters of the vehicle.

25. A system for the automated processing of work authorization requests by a fleet management service from a service provider, the system comprising:
a database for storing information relating to a service history of a vehicle and service codes for denoting vehicle services and acceptable costs for the services;
a communication module configured to receive information from the service provider;
vehicle history evaluation module configured to obtain and process information relating to the status of a vehicle for which the work authorization is requested;
a cost evaluation module configured to determine if a proposed cost received from the communication module for a service for which the work authorization is being requested is below a predetermined value established for the performance of the service; and
a logic module configured to generate a work authorization when the vehicle history evaluation module and cost evaluation module provide an indication that the requested service and cost are appropriate.

26. The system of claim 25 wherein the communication module further includes a speech recognition module configured to receive voice information from the service provider.

27. The system of claim 25 wherein the communication module further includes an interactive voice response module configured to receive information from the service provider.

28. The system of claim 25 wherein the communication module further include a speech recognition module configured to receive voice information from the service provider and an interactive voice response module configured to receive information from the service provider including confirming the voice information.

29. The system of claim 25 further comprising:
a special parameters module configured to provide fleet specific instruction relating to the service and wherein the logic module only generates a work authorization when the fleet specific instructions are applied.

30. The system of claim 25 further comprising:
a parameters module configured to evaluate the service history of the vehicle and the service for which the work authorization is requested in order to determine any additional service that should also be performed.

31. The system of claim 30 wherein the parameters module also evaluates the current status of the vehicle.

32. The system of claim 25 further comprising:
an interface configured to receive a transferred communication from a service provider wherein information relating to the service provider, a vehicle and fleet identification, and what work authorizations have been requested automatically populates the interface when the communication is transferred.
